(19) United States
(12) Patent Application Publication
(10) Pub. No.: US 2019/0219128 A1
(43) Pub. Date: Jul. 18, 2019

(54) BUMP STOPPER

(71) Applicant: Toyo Tire Corporation, Itami-shi, Hyogo (JP)

(72) Inventor: Kouhei Shimomura, Itami-shi (JP)

(73) Assignee: Toyo Tire Corporation, Itami-shi, Hyogo (JP)

(21) Appl. No.: 16/330,464

(22) PCT Filed: Oct. 10, 2017
(86) PCT No.: PCT/JP2017/036653

§ 371 Date: Mar. 5, 2019

(30) Foreign Application Priority Data
Nov. 23, 2016 (JP) 2016-227335

(51) Int. Cl. F16F 9/58; B60G 13/06; B60G 7/04; F16F 1/373

(52) U.S. Cl. CPC F16F 9/58; B60G 13/06; F16F 2230/0023; F16F 1/3735; F16F 2224/0225; B60G 7/04

(57) ABSTRACT

Provided is a bump stopper which is unlikely to buckle. The bump stopper is provided with a cylindrical main body made of polyurethane foam. The main body has a first groove formed in the outer peripheral surface thereof, the first groove being recessed radially inward and extending circumferentially. A ring member, which is harder than polyurethane foam, is mounted in the first groove to be retained on the outer circumferential surface of the main body. The overall axial length L1 of the main body is 66 mm or longer. When an axial distance L2 from a back end of the main body to a surface of the ring member located on the back end side is divided by an axial distance L3 from the front end of the main body to a surface of the ring member located on the front end side, L2/L3 satisfies 3≤L2/L3≤4.2.

### TECHNICAL FIELD

This invention relates to bump stoppers, and more particularly, to a polyurethane-foam bump stopper attached to a rod of a shock absorber.

### BACKGROUND ART

Vehicle's suspensions use a bump stopper to cushion the impact when large vibrations are input from the road wheels to the vehicle body. PTL 1 discloses a cylindrical rubber bump stopper used on a rod projecting from the main body of a shock absorber. It is also known that bump stoppers made of polyurethane foam has greater deformability than rubber bump stoppers.

### CITATION LIST

### Patent Literature

Patent Literature 1: Japanese Unexamined Patent Application Publication No. 2001-138723

### SUMMARY OF INVENTION

### Technical Problem

However, if a polyurethane-foam bump stopper is elongated in the axial direction to extend the time to control the bounce in a bound stroke, the bump stopper deformed by compression may be easily buckled.

The present invention has been made to solve the buckling problem, and has an object to provide an anti-buckling bump stopper.

### Solution to Problem

To achieve the object, the bump stopper recited in claim 1 includes a cylindrical polyurethane-foam main body into which a rod projecting from a shock absorber main body is inserted along an axis, and having a front end in the axial direction at which the shock absorber main body strikes. The main body has a first groove formed on the outer circumferential surface so as to be recessed radially inward and extend in the circumferential direction, and a ring member, which is harder than the polyurethane foam, is fitted in the first groove to be retained on the outer circumferential surface of the main body. The main body has an axial overall length L1 of 66 mm or longer. When an axial distance L2 from a back end of the main body to a first surface of the ring member located on the back end side is divided by an axial distance L3 from the front end of the main body to a second surface of the ring member located on the front end side, L2/L3 satisfies 3≤L2/L3≤4.2.

### Advantageous Effects of Invention

According to the bump stopper recited in claim 1, the ring member, which is harder than the polyurethane foam, is fitted in the first groove formed on the outer circumferential surface of the cylindrical polyurethane-foam main body. The overall length L1 of the main body in the axial direction is 66 mm or longer. When the axial distance L2 from the back end of the main body to the first surface of the ring member located on the back end side is divided by the axial distance L3 from the front end of the main body to the second surface of the ring member located on the front end side, L2/L3 satisfies 3≤L2/L3≤4.2. Thus, the ring member can control the compressive deformation of the main body, thereby making the main body resistant to buckling.

According to the bump stopper recited in claim 2, the first groove has a wall portion located on the back end side along the axis, and the wall portion has an outer diameter greater than that of the ring member, and therefore the wall portion can provide an area to receive pressure from the ring member. Consequently, in addition to the effect of claim 1, the main body can become more resistant to buckling.

According to the bump stopper recited in claim 3, the main body has at least one second groove formed in the outer circumferential surface in a range from the front end to the first groove so as to be recessed radially inward and extend in the axial direction. Since the cross-sectional area of the main body in the range from the front end to the first groove is reduced by the second groove, the main body can be easily inserted into the ring member to fit the ring member in place, and also, when the shock absorber strikes, the front end of the main body can receive the shock absorber with softer spring. Thus, in addition to the effect of claim 1, the bump stopper with the second groove can improve the workability of ring member placement and the ride comfort by cushioning the impact.

### BRIEF DESCRIPTION OF DRAWINGS

FIG. 1 is a cross-sectional view of a suspension including a bump stopper according to an embodiment of the present invention, and the suspension being represented with its axis.

FIG. 2 is a cross-sectional view of the bump stopper with its axis.

FIG. 3 is a plan view of the bump stopper as viewed from the front end thereof in the axial direction.

### DESCRIPTION OF EMBODIMENTS

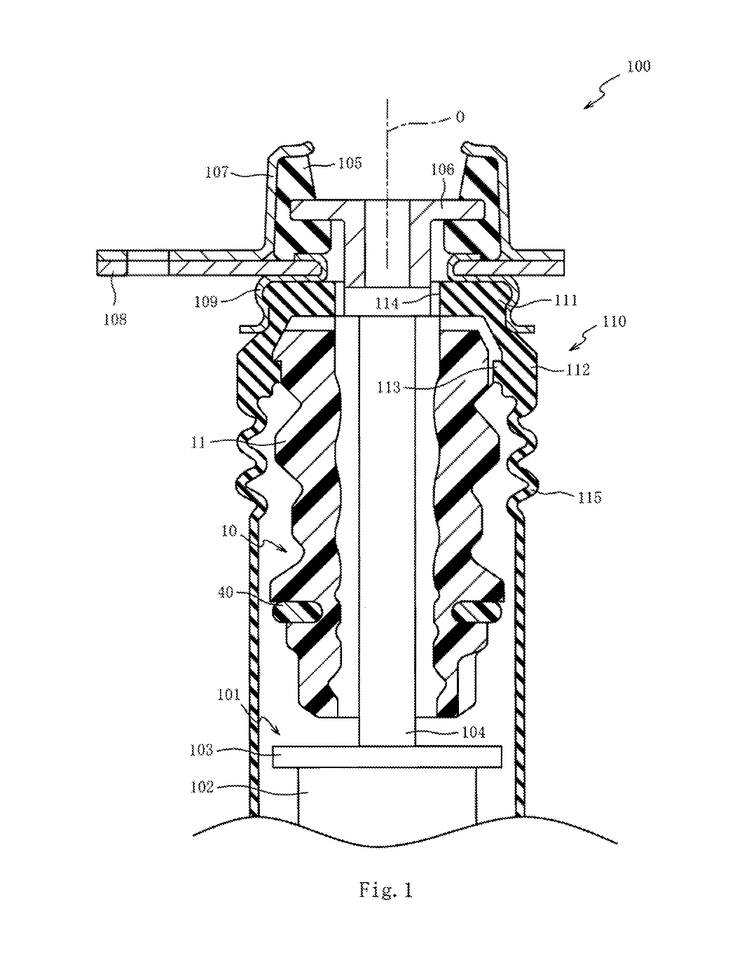

With reference to the accompanying drawings, a preferred embodiment of the present invention will be described below. FIG. 1 is a cross-sectional view of a suspension 100 including a bump stopper 10 according to the embodiment of the invention, the suspension 100 being represented with an O axis thereof. Note that lower part of a shock absorber 101 is omitted in FIG. 1.

As shown in FIG. 1, the suspension 100 mainly includes the shock absorber 101 and a strut mount 105. The shock absorber 101 is a vibration damping device that includes a shock absorber main body 102 filled with fluid and a rod 104 extending from the main body 102 in the O-axis direction. The shock absorber main body 102 has a stuffing box 103 mounted on the top. The rod 104 slidably moves in the inner circumference of a packing attached inside the stuffing box 103.

The strut mount 105 is a rubber component that prevents vibrations and impacts from directly propagating from the road wheels (not shown) to the vehicle body (not shown), and is interposed between an inner metal part 106 and an outer metal part 107. The strut mount 105 is vulcanized to bond to the inner metal part 106, and is inserted in the outer metal part 107. The inner metal part 106 is secured to the upper end of the rod 104 with a nut (not shown), while the outer metal part 107 is secured to the vehicle body (not shown) together with a bracket 108 by a bolt (not shown). A metal fixing part 109 is a bowl-like metal component secured to the bracket 108, and is used to fixedly hold a retaining member 110. The metal fixing part 109 has a hole at the center of the bottom, and the rod 104 passes through the hole.

The retaining member 110 is a rubber component that includes a disk-shaped bottom portion 111 press-fitted inside the metal fixing part 109, a cylindrical wall portion 112 provided on the rim of the bottom portion 111, and an engagement portion 113 projecting inwardly from the inner circumferential surface of the wall portion 112. The bottom portion 111 has a center hole 114 through which the rod 104 passes. The wall portion 112 is formed with a cylindrical cover 115 in one piece. The cover 115 extends to the outside of the shock absorber main body 102.

The bump stopper 10 includes a cylindrical polyurethane-foam main body 11 held by the retaining member 110, and a ring member 40 retained on the outer circumferential surface of the main body 11. The rod 104 is inserted through the main body 11 along the O axis, and the shock absorber main body 102 strikes a front end (lower end in FIG. 1) of the main body 11 in the O-axis direction. The bump stopper 10 interposed between the retaining member 110 and shock absorber main body 102 is compressed in the O-axis direction to cushion the impact.

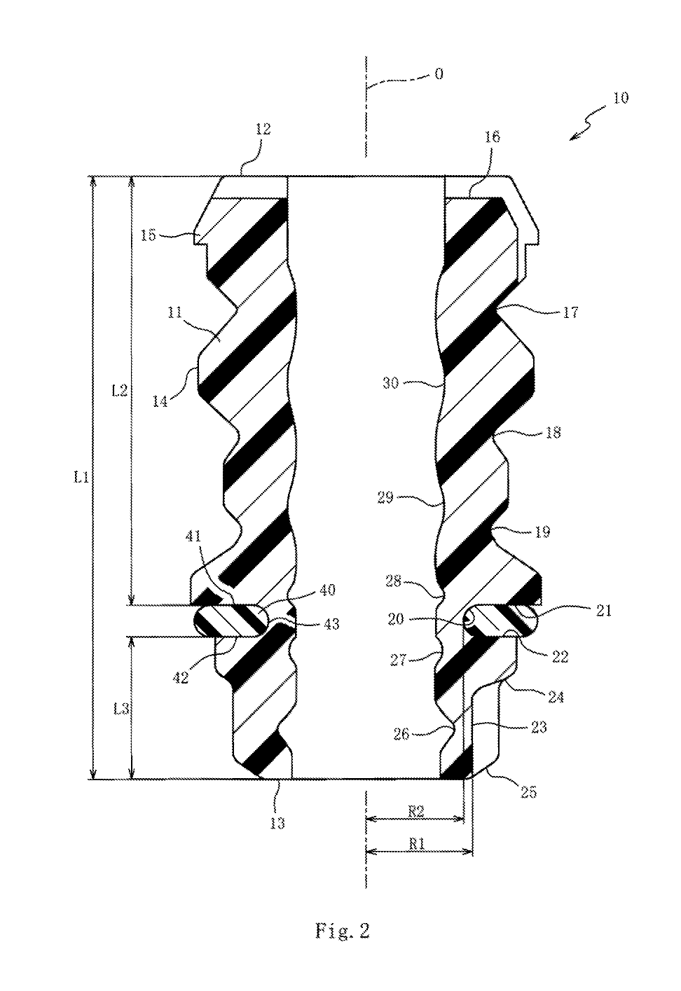

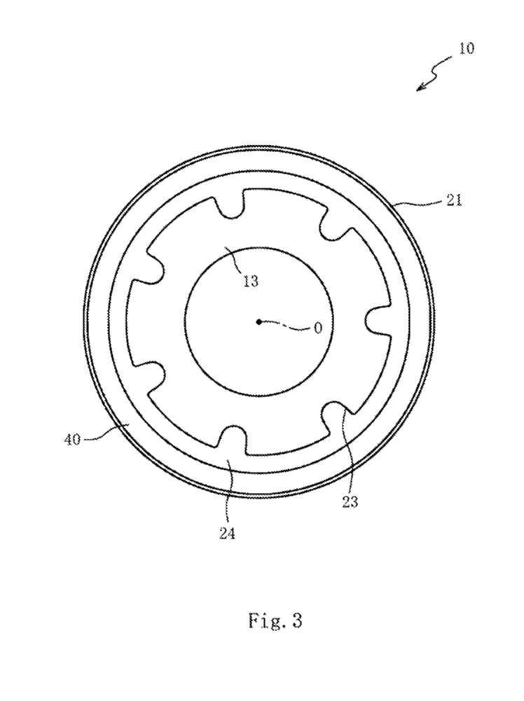

The bump stopper 10 will be further described by referring to FIGS. 2 and 3. FIG. 2 is a cross-sectional view of the bump stopper 10 with the O axis, while FIG. 3 is a plan view of the bump stopper 10 as viewed from the front end in the O-axis direction.

The bump stopper 10 has the main body 11 in the shape of a cylinder extending from a back end 12 to a front end 13 along the O axis. The main body 11 is disposed such that a part thereof on the back end 12 side is held by the retaining member 110 (see FIG. 1), and the front end 13 faces the shock absorber main body 102. The main body 11 has a projecting portion 15 projecting radially outward from the outer circumferential surface 14 near the back end 12. The projecting portion 15 is fitted in between the bottom portion 111 and the engagement portion 113 of the retaining member 110, and consequently the main body 11 is fixedly held by the retaining member 110.

The main body 11 has a plurality of radially extending grooves 16 on the back end 12. The grooves 16 extend such that their ends are not closed by the retaining member 110 when the main body 11 is fixedly held by the retaining member 110 (see FIG. 1). These open ends of the grooves 16 can keep the interface between the retaining member 110 and back end 12 unsealed when the main body 11 is compressed, thereby preventing the main body 11 from making abnormal noise during its restoration.

The main body 11 has a first constricted portion 17, a second constricted portion 18, and a third constricted portion 19 formed on the outer circumferential surface 14 in this order from the back end 12 while leaving spaces therebetween in the O-axis direction. These constricted portions are ring-shaped portions recessed radially inward and extending in the circumferential direction. The main body 11 has a first groove 20 on the outer circumferential surface 14. The first groove 20 is located closer to the front end 13 than the third constricted portion 19 is, and is a ring-shaped groove recessed radially inward and extending in the circumferential direction. The first groove 20 is a region in which the ring member 40 is placed.

The ring member 40 is made of a material harder than the polyurethane foam making up the main body 11. In this embodiment, the ring member 40 is made of a synthetic resin. When the main body 11 is compressed, the ring member 40 restrains the main body 11 in the radial direction to prevent a part of the main body 11 located on the front end 13 side from expanding radially outward.

The first groove 20 includes a first wall portion 21 located on the back end 12 side in the O-axis direction, and a second wall portion 22 located on the front end 13 side in the O-axis direction. The first wall portion 21 is opposed to the second wall portion 22 in the O-axis direction. The first wall portion 21 is a surface making contact with a first surface 41 of the ring member 40 located on the back end 12 side in the O-axis direction. The second wall portion 22 is a surface making contact with a second surface 42 of the ring member 40 located on the front end 13 side in the O-axis direction.

The ring member 40 has an inner circumferential end 43 making contact with the bottom of the first groove 20. The first wall portion 21 of the first groove 20 is larger in outer diameter than the second wall portion 22 of the first groove 20. Since the second wall portion 22 has an outer diameter smaller than that of the ring member 40, the ring member 40 can be easily placed in the first groove 20 from the front end 13 of the main body 11. In addition, since the first wall portion 21 has an outer diameter greater than that of the ring member 40, the first wall portion 21 can provide an area to receive pressure from the ring member 40. Therefore, the first wall portion 21 can disperse the load on the compressed bump stopper 10, thereby helping limit the main body 11 from buckling.

The main body 11 has a second groove 23 that is formed on the outer circumferential surface 14 in a range from the front end 13 to the first groove 20 so as to be recessed radially inward and extend in the O-axis direction. The front end of the second groove 23 in the O-axis direction is connected to the front end 13 of the main body 11, and the back end of the second groove 23 in the O-axis direction is located closer from the front end 13 than the first groove 20 is. The back end of the second groove 23 is closed by an inclined surface 24 communicating with the second wall portion 22. The inclined surface 24 increases in diameter toward the back end 12 in the O-axis direction. The inclined surface 24, which is located closer to the front end 13 than the first groove 20 is, facilitates the ring member 40 to be placed in the first groove 20 from the front end 13 of the main body 11.

As shown in FIG. 3, a plurality of the second grooves 23 are formed at the front end 13 of the main body 11. Since the cross-sectional area of the main body 11 in the range from the front end 13 to the first groove 20 is reduced by the second grooves 23, the main body 11 can be easily inserted into the ring member 40 to fit the ring member 40 in place. In addition, when the shock absorber main body 102 strikes, the front end 13 of the main body 11 can receive the shock absorber main body 102 with softer spring. Thus, the second grooves 23 can increase the workability to place the ring member 40, and also can cushion the impact to improve ride comfort.

Referring back to FIG. 2, the description will be continued. The main body 11 has an inclined surface 25 that communicates with a radially outer side of the front end 13. The front end 13 is a plane orthogonal to the O axis, and the inclined surface 25 increases in diameter toward the back end 12 in the O-axis direction. The main body 11 with the inclined surface 25 can have softer spring at the front end 13 in comparison with the main body 11 without the inclined surface 25. Therefore, the inclined surface 25 can enhance cushioning against the impact generated by the shock absorber main body 102 striking the main body 11.

As seen in the cross section including the O axis (FIG. 2), the distance R1 from the O axis to the bottom of the second groove 23 of the main body 11 is set to be greater than the distance R2 from the O axis to the bottom of the first groove 20. Consequently, the main body 11 in a range from the front end 13 to the first groove 20 has a certain radial thickness, thereby ensuring rigidity of the part of the main body 11 having the second grooves 23 and located on the front end 13 side.

The main body 11 has a fourth constricted portion 26 formed on the inner circumferential surface so as to be opposed to the second groove 23, and a fifth constricted portion 27 formed on the inner circumferential surface between the second groove 23 and first groove 20. The main body 11 has a sixth constricted portion 28 formed on the inner circumferential surface between the first groove 20 and third constricted portion 19, and a seventh constricted portion 29 formed on the inner circumferential surface between the second constricted portion 18 and third constricted portion 19. In addition, the main body 11 has an eighth constricted portion 30 formed on the inner circumferential surface between the first constricted portion 17 and second constricted portion 18. The shape of the compressed main body 11 is determined by design of these constricted portions 17, 18, 19, 26, 27, 28, 29, 30. The number, depth, position, and shape of the constricted portions are not limited to those described above, and can be set appropriately.

The overall length L1 of the main body 11, from the back end 12 to the front end 13, in the O-axis direction is set to 66 mm or longer. With an increase in the overall length L1 of the main body 11, the bump stopper 10 can take a longer time to control bounce during a bound stroke. Therefore, the feeling during bound strokes can be easily designed.

In the case where the bump stopper has a main body 11 whose overall length L1 from the back end 12 to the front end 13 in the O-axis direction is set to less than 66 mm, the front end 13 is hard to expand radially outward when the main body 11 is compressed in the O-axis direction, and therefore the ring member 40 used to retain the main body 11 in the radial direction can be dispensed with. Thus, the targeted bump stopper 10 should have a main body 11 having an overall length L1 of 66 mm or longer, and a ring member 40 retained on the outer circumferential surface 14 of the main body 11.

Assume that the distance from the back end 12 to the first surface 41 (first wall portion 21 of the first groove 20) of the ring member 40 on the back end 12 side in the O-axis direction is denoted as a distance L2, and the distance from the front end 13 to the second surface 42 (second wall portion 22 of the first groove 20) of the ring member 40 on the front end 13 side in the O-axis direction is denoted as a distance L3, L2/L3 of the main body 11 satisfies 3≤L2/L3≤4.2. The ring member 40 retained in this range of the main body 11 in the O-axis direction can control compressive deformation of the main body 11, thereby making the main body 11 resistant to buckling.

### Example

The present invention will be further described with an example; however, the invention is not limited to the example.

Samples 1 to 6 prepared are bump stoppers 10, as described in the embodiment, equipped with polyurethane-foam main bodies 11 with different overall lengths L1 and different distances L2, L3 as shown in Table 1. Note that the inner diameters and outer diameters of the samples are average values including the constricted portions formed on the outer circumferential surface and inner circumferential surface.

TABLE 1

| | | | | | Inner | Outer | |
|---|---|---|---|---|---|---|---|
| | L1 | L2 | L3 | L2/L3 | Diameter | Diameter | |
| No | (mm) | (mm) | (mm) | (—) | (mm) | (mm) | Buckling |
| 1 | 90.4 | 64.5 | 21.4 | 3.0 | 21 | 44 | ◯ |
| 2 | 72.0 | 55.0 | 13.0 | 4.2 | 22 | 43 | ◯ |
| 3 | 72.0 | 55.0 | 13.0 | 4.2 | 29 | 48 | ◯ |
| 4 | 66.0 | 49.0 | 13.0 | 3.8 | 23 | 42 | ◯ |
| 5 | 81.0 | 64.0 | 13.0 | 4.9 | 21 | 44 | X |
| 6 | 99.6 | 82.0 | 13.6 | 6.0 | 19 | 40 | X |

The samples with a rod inserted therethrough were fixedly held at the back end 12 of the main body 11, and a force was applied to the front end 13 by using a pressure plate to compress the samples in the O-axis direction to be 20% of the length L1. The samples were compressed the same number of times, and were visually checked whether they were buckled or not. The samples that were not buckled are determined to be “good: ∘”, and the buckled samples are determined to be “unsatisfactory: x”, and the determination results are shown in Table 1.

As shown in Table 1, among the samples 1 to 6 having overall lengths L1 of 66 mm or longer, samples 1 to 4 that satisfies 3≤L2/L3≤4.2 were not buckled, while samples 5 and 6 that do not satisfy 3≤L2/L3≤4.2 were buckled. According to this example, it is apparent that the main body 11 that satisfies 3≤L2/L3≤4.2 can be made resistant to buckling.

Although the present invention has been described with reference to the embodiment, it can be readily inferred that the invention is not limited to the embodiment, and various modifications can be made without departing from the scope of the invention. For instance, the number, depth, position, and shape of the constricted portions are merely examples, and can be set appropriately.

Although the ring member 40 retained on the outer circumferential surface 14 of the main body 11 is made of a synthetic-resin in the above-described embodiment, the present invention is not always limited to the material. Because the ring member 40 is used to restrain the deformation of the main body 11, it is of course acceptable to employ a metal ring member 40.

1. A bump stopper comprising a cylindrical polyurethane-foam main body into which a rod projecting from a shock absorber main body is inserted along an axis, and the main body having a front end in the axial direction at which the shock absorber main body strikes, wherein
the main body has a first groove formed on an outer circumferential surface thereof, the first groove being recessed radially inward and extending in a circumferential direction,
the bump stopper includes a ring member fitted in the first groove to be retained on the outer circumferential surface, and being harder than the polyurethane foam,
the main body has an axial overall length L1 of 66 mm or longer, and
when an axial distance L2 from a back end of the main body to a first surface of the ring member located on the back end side is divided by an axial distance L3 from the front end of the main body to a second surface of the ring member located on the front end side, L2/L3 satisfies 3≤L2/L3≤4.2.

2. The bump stopper according to claim 1, wherein
the first groove has a wall portion located on the back end side in the axial direction, and the wall portion has an outer diameter greater than that of the ring member.

3. The bump stopper according to claim 1, wherein
the main body has at least one second groove formed on the outer circumferential surface in a range from the front end to the first groove, the second groove being recessed radially inward and extending in the axial direction.
